(19) United States
(12) Patent Application Publication
(10) Pub. No.: US 2008/0026332 A1
(43) Pub. Date: Jan. 31, 2008

(54) Developing agent and manufacturing method thereof

(75) Inventors: Takashi Urabe, Sunto-gun (JP); Tsuyoshi Ito, Izunokuni (JP); Motonari Udo, Mishima (JP); Masahiro Ikuta, Mishima (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/455,464

(22) Filed: Jun. 19, 2006

(51) Int. Cl. G03C 5/00

(52) U.S. Cl. 430/331

(57) ABSTRACT

A developing agent comprises first and second resin fine particles containing a colorant and a release agent and different in weight average molecular weight, and a concentration of the release agent which is softened at a low temperature in the second resin fine particles having the high weight average molecular weight is higher than a concentration of the release agent in the first resin fine particles, whereby thermal properties dependent on the weight average molecular weight of the resin fine particles are made uniform and fixability of the developing agent is improved.

### BACKGROUND OF THE INVENTION

1. Field of the Invention

The present invention relates to a developing agent and a manufacturing method thereof which are used in image forming apparatus such as a copying machine and a printer.

2. Description of the Related Art

Generally in image forming apparatus, an electrical latent image is first formed on an electrostatic latent image support member such as a photoconductor. This latent image is developed with a toner. The developed toner image is transferred onto a transfer medium such as paper. Fixing is conducted by heating and pressing to form an image. Toner particles employed in the image formation are used as a two-component developing agent by being mixed with carrier particles. Alternatively, magnetic toner particles or non-magnetic toner particles are used singly as a one-component developing agent.

Generally, toner particles comprise materials, for example, a resin as a binder, a colorant, a release agent such as a wax and a charge control agent. In recent years, an emulsion polymerization flocculation method has been employed as a method for forming toner particles. This emulsion polymerization flocculation method can control the form or the surface composition of toner particles in an amorphous to spherical predetermined condition, making it possible to inhibit decrease in developability and deterioration of an image quality.

In such toner particles, the improvement in fixability to a transfer medium has been required for further improving an image quality and reliability. For the improvement in fixability, it is required that toner particles are fixed on a transfer medium with a low energy and occurrence of an offset phenomenon at high temperatures is inhibited. In general, regarding a resin as a binder in toner particles, a low-molecular-weight resin is softened at low temperatures to be able to fix on a transfer medium with a low energy. However, viscoelasticity is decreased at high temperatures, for which an offset phenomenon occurs. Meanwhile, a high-molecular-weight resin inhibits a decrease in viscoelasticity at high temperatures. However, a softening temperature is high which requires a high energy for fixing on a transfer medium. Thus, the characteristics that dominate the fixability vary with the molecular weight of the resin. Accordingly, for improving the fixability, it is necessary to control a molecular weight distribution of a resin in forming toner particles.

Nevertheless, when a resin with a molecular weight distribution merely controlled is mixed with a colorant and wax, an irregular distribution of resin fine particles different in molecular weight distribution occurs within toner particles. There is a problem that fixability is decreased by non-uniform viscoelasticity. Further, since it is difficult to strictly control dispersibility of each particle, a colorant or a release agent such as wax is exposed to surfaces of toner particles at a certain rate, a problem arises that poor charging or carrier contamination occurs.

For inhibiting charge contamination, Japan Patent Publication No. 2005-31512 discloses a technique that a surface of a colorant is coated with organic fine particles. However, it does not refer to control of a molecular weight distribution of a resin or improvement in fixability.

### SUMMARY OF THE INVENTION

The invention provides a developing agent and a manufacturing method thereof which can make uniform thermal properties dependent on a weight average molecular weight of resin fine particles, improve fixability and charge stability of the developing agent and inhibit carrier contamination.

According to one embodiment of the invention, there is provided a developing agent comprising first resin fine particles containing a release agent and/or a colorant, and second resin fine particles containing at least a release agent and having a weight average molecular weight higher than that of the first resin fine particles, wherein a concentration of the release agent in the second fine particles being higher than a concentration of the release agent in the first resin fine particles.

According to another embodiment of the invention, there is provided a developing agent comprising first resin fine particles containing a colorant, and second resin fine particles containing a release agent and having a weight average molecular weight higher than that of the first resin fine particles.

According to still another embodiment of the invention, there is provided a method for manufacturing a developing agent, the method comprising stirring a dispersion medium having at least a release agent dispersed to produce fine particles of the release agent, adding the fine particles of the release agent into a first dispersion medium having a monomer dispersed and polymerizing the monomer in the presence of a polymerization initiator to produce first resin fine particles containing the release agent, adding fine particles of a release agent into a second dispersion medium having a monomer dispersed and polymerizing the monomer in the presence of a polymerization initiator to produce second resin fine particles having a weight average molecular weight higher than a weight average molecular weight of the first resin fine particles and having a concentration of the release agent contained higher than a concentration of the release agent of the first resin fine particles, aggregating the first resin fine particles and the second resin fine particles.

According to the other embodiment of the invention, there is provided a method for manufacturing a developing agent, the method comprising stirring a dispersion medium having a colorant dispersed to produce fine particles of the colorant, stirring a dispersion medium having a release agent dispersed to produce fine particles of the release agent, adding the fine particles of the colorant into a first dispersion medium having a monomer dispersed and polymerizing the monomer in the presence of a polymerization initiator to produce first resin fine particles containing the colorant, adding the fine particles of the release agent in to a second dispersion medium having a monomer dispersed and polymerizing the monomer in the presence of a polymerization initiator to produce second resin fine particles having a weight average molecular weight higher than a weight average molecular weight of the first resin fine particles, aggregating the first resin fine particles and the second resin fine particles.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

FIG. 1 is a table showing the results of evaluating a weight average molecular weight, addition amounts of a colorant and a release agent, fixability, charge stability and a carrier contamination amount in Examples and Comparative Examples of the invention.

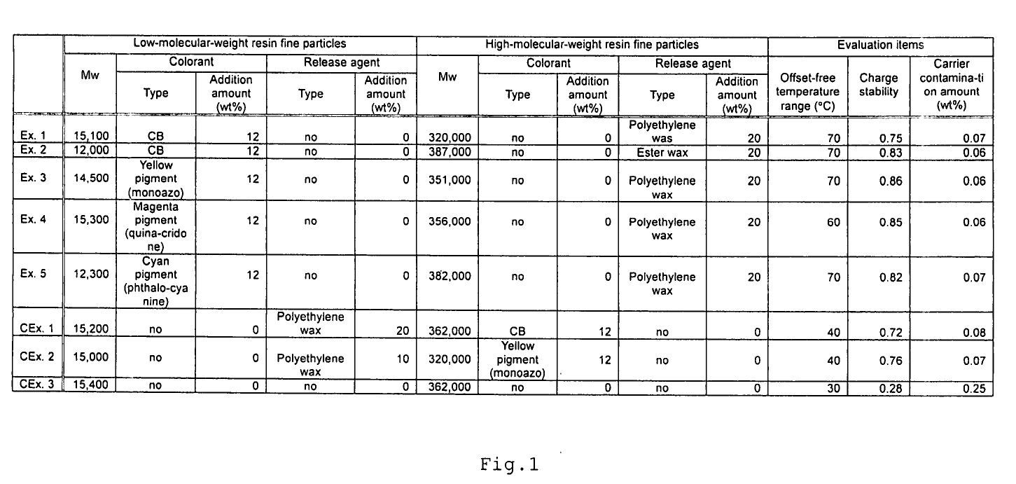

FIG. 2 is a table showing the results of evaluating a weight average molecular weight, addition amounts of a colorant and a release agent, fixability, charge stability and a carrier contamination amount in Examples and Comparative Examples of the invention.

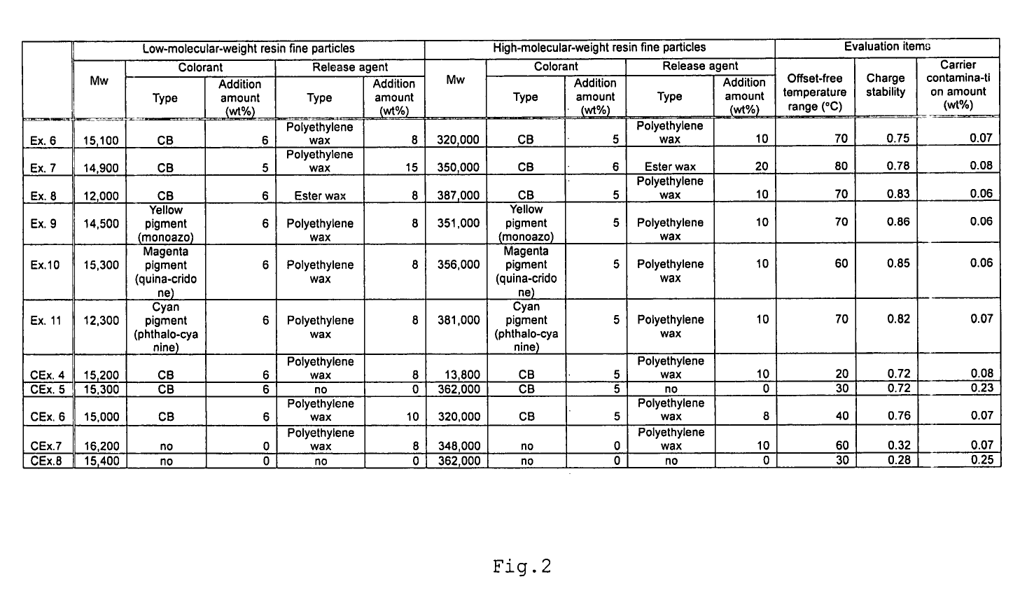

### DETAILED DESCRIPTION OF THE EMBODIMENTS

A developing agent according to one embodiment of the invention is characterized by comprising first resin fine particles containing a release agent and/or a colorant, and second resin fine particles containing at least a release agent and having a weight average molecular weight higher than that of the first resin fine particles, wherein a concentration of the release agent in the second fine particles being higher than a concentration of the release agent in the first resin fine particles.

A developing agent according to another embodiment of the invention comprises first resin fine particles containing a colorant, and second resin fine particles containing a release agent and having a weight average molecular weight higher than that of the first resin fine particles.

As the colorant here, carbon black, organic or inorganic pigments or dyes, and the like are used. As carbon black, for example, acetylene black, furnace black, thermal black, channel black and Ketjen black are available.

As a yellow pigment, it is advisable to use, for example, C.I. pigment yellows 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183 and 185 and C.I. vat yellows 1, 3 and 20 either singly or as a mixture of two or more thereof.

As a magenta pigment, it is advisable to use, for example, C.I. pigment reds 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209 and 238, C. I. pigment violet 19 and C. I. vat reds 1, 2, 10, 13, 15, 23, 29 and 35 either singly or as a mixture of two or more thereof.

As a cyan pigment, it is advisable to use C. I. pigment blues 2, 3, 15, 16 and 17, C. I. vat blue 6, C. I. acid blue 45 and the like either singly or as a mixture of two or more thereof.

In such a colorant, it is advisable that a dispersion diameter of the colorant fine particles is from 0.1 to 1.5 μm. When it is less that 0.1 μm, primary particles of the colorant have to be pulverized, and production cost is abruptly increased. Meanwhile, when it exceeds 1.5 μm, finally obtained toner particles are increased in size, making it difficult to obtain reproducibility of thin lines in fixing on a transfer medium.

As the release agent, it is possible to use, for example, aliphatic hydrocarbon waxes such as low-molecular-weight polyethylene, low-molecular-weight polypropylene, a polyolefin copolymer, polyolefin wax, microcrystalline wax, paraffin wax and Fischer-Tropsch wax; oxides of aliphatic hydrocarbon waxes such as polyethylene oxide wax or block copolymers of these; vegetable waxes such as candelilla wax, carnauba wax, Japan wax, jojoba wax and rice wax; animal waxes such as beeswax, lanolin and spermaceti wax; mineral waxes such as ozocerite, ceresine and petrolactam; waxes made mainly of fatty acid esters, such as montanic acid ester wax and castor wax; and fatty acid esters a part or the whole of which is deoxidized, such as deoxidized carnauba wax.

It is further possible to use saturated linear fatty acids such as palmitic acid, stearic acid, montanic acid and long-chain alkyl carboxylic acids having a long-chain alkyl group; unsaturated fatty acids such as brassidic acid, eleostearic acid and barinaric acid; saturated alcohols such as stearyl alcohol, eicosyl alcohol, behenyl alcohol, carnaubyl alcohol, seryl alcohol, melissyl alcohol and long-chain alkyl alcohol having a long-chain alkyl group; polyhydric alcohols such as sorbitol; fatty acid amides such as linoleic acid amide, oleic acid amide and lauric acid amide; saturated fatty acid bisamides such as methylenebisstearic acid amide, ethylenebiscapric acid amide, ethylenebislauric acid amide and hexamethylenebisstearic acid amide; unsaturated fatty acid amides such as ethylenebisoleic acid amide, hexamethylenebisoleicacidamide, N,N′-dioleyladipic acid amlde and N,N′-dioleylsebacic acid amide; aromatic bisamides such as m-xylenebisstearic acid amide and N,N′-distearylisophthalic acid amide; fatty acid metal salts which are generally called metallic soaps, such as calcium stearate, calcium laurate, zinc stearate and magnesium stearate; aliphatic hydrocarbon waxes grafted with vinyl monomers such as styrene and acrylic acid; partial esters of fatty acids and polyhydric alcohols such as behenic acid monoglyceride; and hydroxyl group-containing methyl ester compounds obtained by hydrogenating vegetable oils.

In this release agent, it is advisable that a melting point is from 60 to 140° C. When it is less than 60° C., shelf stability as a powder is decreased. When it exceeds 140° C., it is difficult to conduct fixing on a transfer medium with a low energy. It is advisable that a dispersion diameter of the release agent fine particles is from 0.1 to 1.5 μm. When it is less than 0.1 μm, a releasing effect is decreased to worsen fixability. Meanwhile, when it exceeds 1.5 μm, finally obtained toner particles are increased in size, and it is difficult to obtain reproducibility of thin lines in fixing on a transfer medium.

As the resin fine particles, it is possible to use, for example, fine particles made of styrenic resins such as polystyrene, a styrene/butadiene copolymer and a styrene acrylic copolymer, ethylenic resins such as polyethylene, a polyethylene/vinyl acetate copolymer and a polyethylene/vinyl alcohol copolymer, a polyester resin, an acrylic resin, a phenolic resin, an epoxy resin, an allyl phthalate resin, a polyamide resin and a maleic acid resin. These resins may be used either singly or in combination of two or more thereof.

It is advisable that a volume average particle size of the resin fine particles is from 0.3 to 2 μm. When it is less than 0.3 μm, it is difficult to coat well the colorant fine particles and the release agent fine particles and to inhibit insufficient charging or carrier contamination caused by exposure of the colorant fine particles and the release agent fine particles. Meanwhile, when it exceeds 2 μm, the finally obtained toner particles are increased in size, making it difficult to obtain reproducibility of thin lines in fixing on a transfer medium.

It is advisable that the weight average molecular weight of the first resin fine particles is from 1,000 to 100,000. When it is less than 1,000, a softening temperature is too low, and shelf stability or controllability as a toner is deteriorated. Meanwhile, when it exceeds 100,000, the softening temperature is too high, making it difficult to conduct fixing on a transfer medium with a low energy. The second resin fine particles have a weight average molecular weight higher than that of the first resin fine particles.

In this developing agent of the invention, a charge control agent for controlling a charge amount of frictional charging may be incorporated. As the charge control agent, a metal-containing azo compound or a metal-containing salicylic acid derivative compound is used. It is advisable that the metal-containing azo compound is a complex or a complex salt of a metallic element such as iron, cobalt or chromium or a mixture thereof. It is advisable that the metal-containing salicylic acid derivative compound is a complex or a complex salt of a metallic element such as zirconium, zinc, chromium or boron or a mixture thereof.

A method for manufacturing a developing agent according to still another embodiment of the invention comprises stirring a dispersion medium having at least a release agent dispersed to produce fine particles of the release agent, adding the fine particles of the release agent into a first dispersion medium having a monomer dispersed and polymerizing the monomer in the presence of a polymerization initiator to produce first resin fine particles containing the release agent, adding fine particles of a release agent into a second dispersion medium having a monomer dispersed and polymerizing the monomer in the presence of a polymerization initiator to produce second resin fine particles having a weight average molecular weight higher than a weight average molecular weight of the first resin fine particles and having a concentration of the release agent contained higher than a concentration of the release agent of the first resin fine particles, aggregating the first resin fine particles and the second resin fine particles.

A method for manufacturing a developing agent according to the other embodiment of the invention comprises stirring a dispersion medium having a colorant dispersed to produce fine particles of the colorant, stirring a dispersion medium having a release agent dispersed to produce fine particles of the release agent, adding the fine particles of the colorant into a first dispersion medium having a monomer dispersed and polymerizing the monomer in the presence of a polymerization initiator to produce first resin fine particles containing the colorant, adding the fine particles of the release agent into a second dispersion medium having a monomer dispersed and polymerizing the monomer in the presence of a polymerization initiator to produce second resin fine particles having a weight average molecular weight higher than a weight average molecular weight of the first resin fine particles, aggregating the first resin fine particles and the second resin fine particles.

As the monomer for forming the resin fine particles, a radical-polymerizable monomer is used. It is possible to use, for example, aromatic vinyl monomers such as styrene, methylstyrene, methoxystyrene, phenylstyrene and chlorostyrene, ester-type monomers such as methyl acrylate, ethyl acrylate, butyl acrylate, methyl methacrylate, ethyl methacrylate and butyl methacrylate, carboxylic acid-containing monomers such as acrylic acid, methacrylic acid, fumaric acid and maleic acid, amine-type monomers such as aminoacrylate, acrylamide, methacrylamide, vinylpyridine and vinylpyrrolidone and derivatives thereof either singly or as a mixture of two or more thereof.

As a chain transfer agent, it is possible to use, for example, compounds having a mercapto group (SH) for forming low-molecular-weight compounds, such as octanethiol, decanethiol, dodecanethiol and 3-mercaptopropionic acid ester.

The dispersion medium refers to, for example, a medium containing 40% by weight or more of water. It may contain a dispersing agent such as a nonionic surfactant, an anionic surfactant or a cationic surfactant. As the nonionic surfactant, for example, high-molecular-weight surfactants such as polyethylene glycols, alkylphenol ethylene oxide adducts and polyhydric alcohols may be used either singly or in combination of two or more thereof. As the anionic surfactant, for example, sulfuric acid ester salts, sulfonic acid salts and phosphoric acid esters can be used. As the cationic surfactant, for example, amine salts and quaternary ammonium salts can be used.

As the polymerization initiator, a water-soluble initiator or an oil-soluble initiator can be used according to a polymerization method. As the water-soluble initiator, for example, persulfates such as potassium persulfate and ammonium persulfate, azo compounds such as 2,2-azobis(2-aminopropane) and 2,2-azobisisobutylamidine hydrochloride, hydrogen peroxide and benzoyl peroxide are used. As the oil-soluble initiator, for example, azo compounds such as azobisisobutyronitrile and azobisdimethylvaleronitrile and peroxides such as benzoyl peroxide and dichlorobenzoyl peroxide are used. As required, a sulfur-containing reducing agent or the like can be used as a redox initiator. As the reducing agent, for example, a hydrogensulfite or a hydrogensulfite containing 50% or less of another sulfur-containing reducing agent such as thiosulfuric acid can be used. Further, as required, a divalent iron ion may be used in combination as a catalyst.

Incidentally, these materials are not limited to the foregoing materials, and materials can selectively be used as occasion demands.

After flocculation, the first resin fine particles and the second resin fine particles dispersed in a solution are fused by being heated at a temperature of at least a glass transition temperature Tg of the resin or at least a melting point of the release agent, and further undergo a washing and drying step to form toner particles.

Inorganic fine particles for adjusting fluidity and chargeability may externally be added to such toner particles in an amount of from 0.01 to 10% by weight. As the inorganic fine particles, silica, titania, alumina, strontium titanate, tinoxide and the like can be used either singly or as a mixture of two or more thereof. From the standpoint of environmental stability, it is advisable to use inorganic fine particles surface-treated with a hydrophobic agent. Further, for improving cleanability, resin fine particles having a diameter of 1 μm or less may externally be added.

As a mixer for such inorganic fine particles and the like, for example, a Henschel mixer (manufactured by Mitsui Mining), Super Mixer (manufactured by Kawata), Ribocorn (manufactured by Okawara Seisakusho), Nautor Mixer, Turburizer, Cyclomix (manufactured by Hosokawa Micron), Spiral Pin Mixer (manufactured by Taiheiyo Kiko) or Redige Mixer (manufactured by Matsubo) can be used.

Coarse particles formed, such as toner particles, may be sieved. As a sieve, Ultrasonic (manufactured by Koei Sangyo), Resona Sieve, Gyro Shifter (manufactured by Tokuju Kosakusho), Vibra Sonic System (manufactured by Dalton), Soni Clean (manufactured by Shinto Kogyo), Turbo Screener (manufactured by Turbo Kogyo), Micro Shifter (manufactured by Makino Sangyo), a circular vibration sieve or the like can be used.

The thus-formed toner particles become singly a one-component developing agent. A two-component developing agent is formed by mixing the same with carrier particles.

The invention is illustrated specifically below by referring to Examples. In the following Examples and Comparative Examples, a molecular weight of a resin was measured using GPC (Gel Permeation Chromatography). Alliance 2695 manufactured by Waters was used as a measuring device, and 2414 manufactured by Waters as a detector. A sample was dissolved in tetrahydrofuran (THF), and a soluble matter was measured by GPC. A calibration curve of a molecular weight was prepared on the basis of polystyrene using polystyrene standard particles.

A volume average particle size was measured using COLTER MULTISIZER II (manufactured by Coulter Electronics Limited).

### EXAMPLE 1

First, a dispersion of colorant fine particles and a dispersion of release agent fine particles were prepared as follows.

(Preparation of a Dispersion of Colorant Fine Particles)

20 wt % of carbon black as a colorant and 1 part by weight of sodium dodecylbenzenesulfonate as a dispersing agent were mixed with 79 wt % of deionized water, and they were dispersed with a homogenizer (manufactured by IKA) for 60 minutes to prepare a dispersion of colorant fine particles having a volume average particle size of 207 nm.

(Preparation of a Dispersion of Release Agent Fine Particles)

20 wt % of polyethylene wax as a release agent and 1 part by weight of sodium dodecylbenzene sulfonate were mixed with 79 wt % of deionized water, and they were dispersed with a homogenizer (manufactured by IKA) for 10 minutes to prepare a dispersion of release agent fine particles having a volume average particle size of 152 nm.

A developing agent was formed in the following manner using the thus-prepared dispersion of colorant fine particles and dispersion of release agent fine particles.

(Formation of Low-Molecular-Weight Resin Fine Particles)

30 wt % of styrene, 8 wt % of butyl acrylate and 2 wt % of acrylic acid as radical-polymerizable monomers, 1 part by weight of a dodecanethiol as a chain transfer agent and 24.7 wt % of the prepared dispersion of colorant fine particles (the colorant solid content was 12 wt % relative to the resin solid content) were incorporated into a dispersion medium obtained by dispersing 0.4 part by weight of sodium dodecylbenzenesulfonate as a dispersing agent in 25.3 wt % of deionized water, and they were emulsified in a flask. The resulting emulsion was heated in a nitrogen atmosphere to raise the temperature to 70° C.

When the temperature reached 70° C., a solution obtained by dissolving 0.1 part by weight of ammonium persulfate as a polymerization initiator in 8.5 wt % of deionized water was added, and a polymerization reaction was conducted for 5 hours to form low-molecular-weight resin fine particles containing the colorant fine particles. A weight average molecular weight Mw of the low-molecular-weight resin fine particles was 15,100.

(Formation of High-Molecular-Weight Resin Fine Particles)

28 wt % of styrene, 10 wt % of butyl acrylate and 1 part by weight of acrylic acid as radical-polymerizable monomers and 39.1 wt % of the prepared dispersion of release agent fine particles (the release agent solid content was 20 wt % relative to the resin solid content) were incorporated into a dispersion medium obtained by dispersing 0.4 part by weight of sodium dodecylbenzenesulfonate as a dispersing agent in 12.92 wt % of deionized water, and they were emulsified in a flask. The resulting emulsion was heated in a nitrogen atmosphere to raise the temperature to 70° C.

When the temperature reached 70° C., a solution obtained by dissolving 0.08 part by weight of ammonium persulfate as a polymerization initiator in 8.5 wt % of deionized water was added, and a polymerization reaction was conducted for 5 hours to form high-molecular-weight resin fine particles containing the colorant fine particles. A weight average molecular weight Mw of the high-molecular-weight resin fine particles was 320,000.

(Formation of a Developing Agent)

The low-molecular-weight resin fine particles and the high-molecular-weight fine particles were incorporated into a dispersion medium in amounts of 49.5 wt % each as a solid content, and an aluminum sulfate aqueous solution was added as a flocculant in an amount of 1 part by weight as a solid content. While being stirred, raising the temperature to 48° C. at a rate of 1° C./min, and then the mixture was maintained for 2 hours. Further, the temperature was raised to 70° C. at a rate of 1° C./min, and the low-molecular-weight resin fine particles and the high-molecular-weight resin fine particles were fused to form toner particles in which the addition amount of the colorant (carbon black) relative to the amount of the low-molecular-weight resin was 12 wt %, the addition amount of the release agent relative to the amount of the high-molecular-weight resin was 20 wt % and the average volume particle size was 4.8 μm.

The formed toner particles were washed, filtered, and dried. Then, 0.5 part by weight of hydrophobized silica (RX200: manufactured by Nippon Aerogil) was adhered to the surfaces of 100 wt % of the toner particles.

Further, 5 wt % of the toner particles having silica adhered thereto was mixed with 95 wt % of a carrier to form a two-component developing agent.

Fixability, charge stability and an amount of carrier contamination of the thus-obtained developing agent were evaluated.

(Evaluation of Fixing)

Fixing of the resulting developing agent was evaluated. An offset-free temperature range which is a temperature range capable of obtaining a good image was measured by varying a temperature of a fixing unit in a composite machine e-studio 281c manufactured by Toshiba TEC and remodeled for evaluation. The wider offset-free temperature range can comply with the drift of the temperature of the fixing unit. In practice, the range of 50° C. or more is judged to be good. When the offset-free temperature range is 40° C. or less, fixability is decreased, and a rate at which to form a defective image is increased.

As a result of measuring the offset-free temperature range of the resulting developing agent, a good value of 70° C. was obtained as shown in Table 1.

(Evaluation of Charge Stability)

Charge stability of the resulting developing agent was evaluated. A charge amount q/m[HH] after allowing the developing agent to stand for 16 hours under a high-temperature and high-humidity environment such as temperature:30° C., humidity:85% and a charge amount q/m[LL] after allowing the developing agent to stand for 16 hours under a low-temperature and low-humidity such as temperature:10° C., humidity:20% were measured with a suction-type blow-off (TTB-200 manufactured by Kyocera Chemical). When q/m[HH]/q/m[LL] indicating the charge stability is closer to 1, the charge amount is less changed by an environmental atmosphere, and a good image can be obtained. A value of 0.7 or more is judged to be good.

As a result of measuring the charge amount of the resulting developing agent according to the environmental atmosphere, the charge stability was 0.75 as shown in Table 1, and the good value was obtained.

(Evaluation of an Amount of Carrier Contamination)

An amount of carrier contamination of the resulting developing agent was evaluated. In the composite machine e-studio 281c manufactured by Toshiba TEC, passage of 100 sheets was conducted at a printing rate of 10%, and an amount of a material contaminating the surface of the carrier (amount of carrier contamination) was measured. The smaller the amount of carrier contamination, the better for obtaining a good image, and a value of 0.10 part by weight or less is judged to be good.

As a result of measuring the amount of carrier contamination of the resulting developing agent, a good value of 0.07 part by weight was obtained as shown in Table 1.

### EXAMPLE 2

In the same manner as in Example 1, toner particles containing an ester wax as a release agent were formed, and the evaluation was conducted. As a result, good values were obtained as shown in Table 1.

### EXAMPLE 3

In the same manner as in Example 1, toner particles containing a yellow pigment (monoazo) as a colorant were formed, and the evaluation was conducted. As a result, good values were obtained as shown in Table 1.

### EXAMPLE 4

In the same manner as in Example 1, toner particles containing a magenta pigment (quinacridone) as a colorant were formed, and the evaluation was conducted. As a result, good values were obtained as shown in Table 1.

### EXAMPLE 5

In the same manner as in Example 1, toner particles containing a cyan pigment (phthalocyanine) as a colorant were formed, and the evaluation was conducted. As a result, good values were obtained as shown in Table 1.

As shown in these Examples 1 to 5, the toner particles controlled such that the colorant is added to the low-molecular-weight resin amount and the release agent to the high-molecular-weight resin can provide the high fixability and the charge stability and inhibit the carrier contamination.

### EXAMPLE 6

Low-molecular-weight resin fine particles and high-molecular-weight resin fine particles were formed in the following manner using a dispersion of colorant fine particles and a dispersion of release agent fine particles prepared as in Example 1.

(Formation of Low-Molecular-Weight Resin Fine Particles)

30 wt % of styrene, 8 wt % of butyl acrylate and 2 wt % of acrylic acid as radical-polymerizable monomers, 1 part by weight of dodecanethiol as a chain transfer agent, 12.3 wt % of the prepared dispersion of colorant fine particles (the colorant solid content was 6 wt % relative to the resin solid content) and 16.5 wt % of the dispersion of release agent fine particles (the release agent solid content was 8 wt % relative to the resin solid content) were incorporated into a dispersion medium obtained by dispersing 0.4 part by weight of sodium dodecylbenzenesulfonate as a dispersing agent in 21.2 wt % of deionized water, and they were emulsified in a flask. The resulting emulsion was heated in a nitrogen atmosphere to raise the temperature to 70° C.

When the temperature reached 70° C., a solution obtained by dissolving 0.1 part by weight of ammonium persulfate as a polymerization initiator in 8.5 wt % of deionized water was added, and a polymerization reaction was conducted for 5 hours to form low-molecular-weight resin fine particles flocculated by containing the colorant fine particles and the release agent fine particles. A weight average molecular weight Mw of the low-molecular-weight resin fine particles was 15,100.

(Formation of High-Molecular-Weight Resin Fine Particles)

28 wt % of styrene, 10 wt % of butyl acrylate and 1 part by weight of acrylic acid as radical-polymerizable monomers, 9.8 wt % of the prepared dispersion of colorant fine particles (the colorant solid content was 5 wt % relative to the resin solid content) and 19.5 wt % of the dispersion of release agent fine particles (the release agent solid content was 10 wt % relative to the resin solid content) were incorporated into a dispersion medium obtained by dispersing 0.4 part by weight of sodium dodecylbenzenesulfonate as a dispersing agent in 22.72 wt % of deionized water, and they were emulsified in a flask. The resulting emulsion was heated in a nitrogen atmosphere to raise the temperature to 70° C.

When the temperature reached 70° C., a solution obtained by dissolving 0.08 part by weight of ammonium persulfate as a polymerization initiator in 8.5 wt % of deionized water was added, and a polymerization reaction was conducted for 5 hours to form high-molecular-weight resin fine particles containing the colorant fine particles. A weight average molecular weight Mw of the high-molecular-weight resin fine particles was 320,000.

In the same manner as in Example 1, the thus-formed low-molecular-weight resin fine particles and high-molecular-weight resin fine particles were mixed and treated to form toner particles shown in Table 2, and the evaluation was conducted. As a result, good values were obtained as shown in Table 2.

### EXAMPLE 7

In the same manner as in Example 6, toner particles containing carbon black as a colorant and polyethylene wax as a release agent which were different from those in Example 6 as shown in Table 2 were formed, and the evaluation was conducted. As a result, good values were obtained as shown in Table 2.

### EXAMPLE 8

In the same manner as in Example 6, toner particles containing ester wax as a release agent as shown in Table 2 were formed, and the evaluation was conducted. As a result, good values were obtained as shown in Table 2.

### EXAMPLE 9

In the same manner as in Example 6, toner particles containing a yellow pigment (monoazo) as a colorant as shown in Table 2 were formed, and the evaluation was conducted. As a result, good values were obtained as shown in Table 2.

### EXAMPLE 10

In the same manner as in Example 6, toner particles containing a magenta pigment (quinacridone) as a colorant as shown in Table 2 were formed, and the evaluation was conducted. As a result, good values were obtained as shown in Table 2.

### EXAMPLE 11

In the same manner as in Example 6, toner particles containing a cyan pigment (phthalocyanine) as a colorant as shown in Table 2 were formed, and the evaluation was conducted. As a result, good values were obtained as shown in Table 2.

As shown in these Examples 6 to 10, the toner particles in which the amount is intentionally controlled gradiently such that the large amount of the release agent is added to the high-molecular-weight resin fine particles can provide the high fixability and the charge stability and inhibit the carrier contamination. In this gradient control, it is preferable that the rate of the amount of the release agent in the high-molecular-weight resin fine particles to the amount of the release agent in the low-molecular-weight resin fine particles is from 1.1 to 30. When it is less than 1.1, the gradient of the amount of the release agent is too small to make uniform the thermal properties depending on the weight average molecular weight. Meanwhile, when it exceeds 30, the difference in amount of the release agent between the high-molecular-weight fine particles and the low-molecular-weight fine particles is too great. It is more preferably from 1.5 to 20.

### COMPARATIVE EXAMPLE 1

In the same manner as in Example 1, toner particles were formed by adding polyethylene wax as a release agent to low-molecular-weight fine particles and carbon black as a colorant to high-molecular-weight resin fine particles as shown in Table 1, and the evaluation was conducted. As a result, it has been found that an offset-free temperature range is small and good fixability is not obtained as shown in Table 1.

### COMPARATIVE EXAMPLE 2

In the same manner as in Example 1, toner particles were formed by adding polyethylene wax as a release agent to low-molecular-weight fine particles and [ ]as a colorant to high-molecular-weight resin fine particles, and the evaluation was conducted. As a result, it has been found that an offset-free temperature range is small and good fixability is not obtained as shown in Table 1.

### COMPARATIVE EXAMPLE 3

A colorant dispersion and a release agent dispersion were first prepared in the same manner as in Example 1. After low-molecular-weight resin fine particles and high-molecular-weight resin fine particles shown in Table 1 were formed, the release agent dispersion was added such that the colorant solid content was 6 wt % relative to the resin solid content, and the release agent dispersion was added such that the release agent solid content was 10 wt % relative to the resin solid content. Flocculation was conducted by charging a flocculant to form toner particles and conduct evaluation as in Example 1. As a result, it has been found that no good values are obtained in any of the evaluation items as shown in Table 1.

### COMPARATIVE EXAMPLE 4

In the same manner as in Example 6, toner particles were formed using a resin which was prepared similarly to the low-molecular-weight resin fine particles in Example 6 instead of high-molecular-weight resin particles, and the evaluation was conducted. As a result, it has been found that an offset-free temperature range is small and good fixability is not obtained as shown in Table 2.

### COMPARATIVE EXAMPLE 5

In the same manner as in Example 6, toner particles were formed by adding polyethylene wax as a release agent to low-molecular-weight fine particles and carbon black as a colorant to high-molecular-weight resin fine particles, and the evaluation was conducted. As a result, it has been found that an offset-free temperature range is small and good fixability is not obtained as shown in Table 2.

### COMPARATIVE EXAMPLE 6

In the same manner as in Example 6, toner particles were formed by adding polyethylene wax as a release agent such that the amounts of the polyethylene wax added to the low-molecular-weight resin fine particles and the high-molecular-weight fine particles were opposite to those in Example 6 as shown in Table 2, and the evaluation was conducted. As a result, it has been found that an offset-free temperature range is small and good fixability is not obtained as shown in Table 2.

### COMPARATIVE EXAMPLE 7

A colorant dispersion and a release agent dispersion were first prepared in the same manner as in Example 6. After low-molecular-weight resin fine particles and high-molecular-weight resin fine particles shown in Table 2 were formed by adding the release agent dispersion, the colorant dispersion was then added such that the colorant solid content was 6 wt % relative to the resin solid content. Flocculation was conducted by charging a flocculant to form toner particles and conduct the evaluation as in Example 6. As a result, it has been found that good charge stability is not obtained as shown in Table 2.

### COMPARATIVE EXAMPLE 8

A colorant agent dispersion and a release agent dispersion were first prepared in the same manner as in Example 6. After low-molecular-weight resin fine particles and high-molecular-weight resin fine particles shown in Table 1 were formed, the colorant dispersion was added such that the colorant solid content was 6 wt % relative to the resin solid content and the release agent dispersion was added such that the release agent solid content was 10 wt % relative to the resin solid content. Flocculation was conducted by charging a flocculant to form toner particles and conduct the evaluation as in Example 6. As a result, it has been found that good values are not obtained in any of the evaluation items as shown in Table 2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising:
first resin fine particles containing a release agent and/or a colorant; and
second resin fine particles containing at least a release agent and having a weight average molecular weight higher than that of the first resin fine particles,
wherein a concentration of the release agent in the second fine particles being higher than a concentration of the release agent in the first resin fine particles.

2. The developing agent according to claim 1, wherein the first resin fine particles and the second resin fine particles contain the colorant, and the concentration of the colorant in the second resin fine particles is lower than the concentration of the colorant in the first resin fine particles.

3. The developing agent according to claim 1, wherein the first resin fine particles and the second resin fine particles are produced by a polymerization method.

4. The developing agent according to claim 1, wherein the rate of the concentration of the release agent in the second resin fine particles to the concentration of the release agent in the first resin fine particles is from 1.1 to 30.

5. The developing agent according to claim 1, wherein a volume average particle size of the first resin fine particles and the second resin fine particles is from 0.3 to 2 μm.

6. The developing agent according to claim 1, wherein a diameter of the release agent and the colorant is from 0.1 to 1.5 μm.

7. The developing agent according to claim 1, wherein the weight average molecular weight of the first resin fine particles is from 1,000 to 100,000.

8. The developing agent according to claim 1, wherein a melting point of the release agent is from 60 to 140° C.

9. A developing agent comprising:
first resin fine particles containing a colorant; and
second resin fine particles containing a release agent and having a weight average molecular weight higher than that of the first resin fine particles.

10. The developing agent according to claim 9, wherein the first resin fine particles and the second resin fine particles are produced by a polymerization method.

11. The developing agent according to claim 9, wherein a volume average particle size of the first resin fine particles and the second resin fine particles is from 0.3 to 2 μm.

12. The developing agent according to claim 9, wherein a diameter of the colorant and the release agent is from 0.1 to 1.5 μm.

13. The developing agent according to claim 9, wherein the weight average molecular weight of the first resin fine particles is from 1,000 to 100,000.

14. The developing agent according to claim 9, wherein a melting point of the release agent is from 60 to 140° C.

15. A method for manufacturing a developing agent, the method comprising:
stirring a dispersion medium having at least a release agent dispersed to produce fine particles of the release agent;
adding the fine particles of the release agent into a first dispersion medium having a monomer dispersed and polymerizing the monomer in the presence of a polymerization initiator to produce first resin fine particles containing the release agent;
adding fine particles of a release agent into a second dispersion medium having a monomer dispersed and polymerizing the monomer in the presence of a polymerization initiator to produce second resin fine particles having a weight average molecular weight higher than a weight average molecular weight of the first resin fine particles and having a concentration of the release agent contained higher than a concentration of the release agent of the first resin fine particles; and
aggregating the first resin fine particles and the second resin fine particles.

16. The method according to claim 15, further comprising adding fine particles of a colorant into the first and/or second dispersion medium having the monomer dispersed.

17. The method according to claim 15, wherein the weight average molecular weight of the first resin fine particles is from 1,000 to 100,000.

18. A method for manufacturing a developing agent, the method comprising:
stirring a dispersion medium having a colorant dispersed to produce fine particles of the colorant;
stirring a dispersion medium having a release agent dispersed to produce fine particles of the release agent;
adding the fine particles of the colorant into a first dispersion medium having a monomer dispersed and polymerizing the monomer in the presence of a polymerization initiator to produce first resin fine particles containing the colorant;
adding the fine particles of the release agent into a second dispersion medium having a monomer dispersed and polymerizing the monomer in the presence of a polymerization initiator to produce second resin fine particles having a weight average molecular weight higher than a weight average molecular weight of the first resin fine particles; and
aggregating the first resin fine particles and the second resin fine particles.

19. The method according to claim 18, wherein the weight average molecular weight of the first resin fine particles is from 1,000 to 100,000.
